(19) United States
(12) Patent Application Publication
(10) Pub. No.: US 2010/0078371 A1
(43) Pub. Date: Apr. 1, 2010

(54) SEPARATOR

(75) Inventor: Yasuhiro SAITO, Tokoname-shi (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/557,739

(22) Filed: Sep. 11, 2009

(30) Foreign Application Priority Data
Sep. 29, 2008 (JP) 2008-251544

(51) Int. Cl. B01D 35/18; B01D 21/30

(52) U.S. Cl. 210/149; 210/181

(57) ABSTRACT

A separator separates fuel components from oil diluted by fuel in a crossflow filtration method. The separator includes a tubular separator main body; a separation member provided in the separator main body to partition an inside of the separator main body into a first area and a second area, and further to allow the fuel components contained in the oil to permeate and thus separate the fuel components; an oil inlet provided to the separator main body and feeding the oil to the first area; an oil outlet provided to the separator main body and discharging the oil from the first area; a fuel outlet provided to the separator main body and discharging the fuel components from the second area; and a heater provided to an upstream side of the separation member and heating the oil before the oil reaches the separation member.

### CROSS-REFERENCE TO RELATED APPLICATIONS

The present application claims priority under 35 U.S.C. §119 of Japanese Application No. 2008-251544 filed on Sep. 29, 2008, the disclosure of which is expressly incorporated by reference herein in its entirety.

### BACKGROUND OF THE INVENTION

1. Field of the Invention

The present invention relates to a separator, more specifically to a simple-structured separator capable of separating fuel components mixed into lubricating oil for an internal combustion engine, without deteriorating the oil.

2. Description of Related Art

In order to prevent dilution of lubricating oil for an internal combustion engine caused by mixed fuel components, a conventionally known separation method is to increase temperature of the oil so as to gasify and separate the fuel components (refer to Related Arts 1 and 2, for example). It is disclosed in Related Art 1 above that an oil heater provided in a lubricating circuit of an internal combustion engine, increases temperature of lubricating oil, and thereby increases gasification of fuel components, which have mixed or may mix into the lubricating oil. It is disclosed in Related Art 2 above that a heater heating lubricating oil in an oil pan is provided at a bottom portion of the oil pan, so as to control temperature of the lubricating oil and gasify fuel components.
[Related Art 1] Japanese Patent Laid-open Publication No. 2004-190513
[Related Art 2] Japanese Patent Laid-open Publication No. 2004-340056

In Related Arts 1 and 2 above, the heater is used to gasify the fuel components in the oil. Normally, however, the oil temperature during operation of the internal combustion engine is as high as about 130° C., and thus 30% or more of the fuel components in the oil remains. When the temperature is increased to about 200° C., a substantially entire amount of the fuel components contained in the oil can be gasified. In this case, however, a problem arises where the oil itself is deteriorated. In addition, the oil as a whole in the lubricating circuit is heated in both cases. Thus, the heater has a large structure.

### SUMMARY OF THE INVENTION

The embodiments of the present invention are provided to address the problems with the conventional technology above. An advantage of the embodiments of the present invention is to provide a simple-structured separator capable of separating fuel components mixed into lubricating oil for an internal combustion engine, without deteriorating the oil.

One aspect of the present embodiments provides a separator configured to separate fuel components from oil diluted by fuel in a crossflow filtration method, the separator including a tubular separator main body; a separation member provided in the separator main body, and configured to partition an inside of the separator main body into a first area and a second area, and further to allow the fuel components contained in the oil to permeate and thus to separate the fuel components; an oil inlet provided to the separator main body and configured to feed the oil to the first area; an oil outlet provided to the separator main body and configured to discharge the oil from the first area; a fuel outlet provided to the separator main body and configured to discharge the fuel components from the second area; and a heater provided to an upstream side of the separation member and configured to heat the oil before the oil reaches the separation member.

In a further aspect, the separator main body has a cylindrical shape, and the separation member has a cylindrical shape in an axial direction of the separator main body.

In a further aspect, the first area is an area inside the separation member; the second area is an area outside the separation member; the oil inlet and the oil outlet are provided respectively to both end surface portions of the separator main body; and the fuel outlet is provided to a side surface portion of the separator main body.

In a further aspect, the first area is an area outside the separation member; the second area is an area inside the separation member; the oil inlet and the oil outlet are provided respectively to side surface portions of the separator main body; and the fuel outlet is provided to an end surface portion of the separator main body.

In a further aspect, a swirler is further provided and configured to flow the oil in a spiral pattern in the first area.

In a further aspect, a heating controller is provided to activate the heater only when the oil has a temperature lower than a predetermined temperature.

In a further aspect, the separation member is a ceramic filter provided with a separation membrane and a supporting body, the separation membrane having a plurality of fine pores permeable for fuel components, the supporting body having a plurality of fine pores having a diameter larger than that of the fine pores of the separation membrane.

In the separator according to the present embodiments, oil is heated instantaneously and locally by the heater before reaching the separation member, and thus gasification of fuel components is facilitated. The oil whose pressure is increased due to gasification of the fuel components, easily separates the fuel components through the separation member. The fuel components separated from the oil are discharged from the second area through the fuel outlet. The oil from which the fuel components have been separated is discharged from the first area through the oil outlet. As described above, heating the oil facilitates gasification of the fuel components. Further, gasification of the fuel components increases a pressure in a vicinity of the separation member, and thus allows the separation member to facilitate separation of the fuel components. In addition, the fuel components are separated from the locally heated oil by using the separation member. Unlike a conventional separator, the separator of the present embodiments requires no large heater and the like for heating oil as a whole, and thus can have a simple structure. In addition, since the oil only needs to be heated instantaneously and locally, no excessive heating is necessary to increase the temperature of the entire oil. Thus, oil deterioration due to heat can be prevented. Further, energy consumption can be limited compared to the conventional separator. Furthermore, an employed crossflow filtration method prevents solid components, such as sludge in the oil and the like, from depositing on a surface of the separation member and clogging the separation member, and thereby prevents a decline in performance of the separation member.

When the separator main body has a cylindrical shape, and the separation member has a cylindrical shape in the axial direction of the separator main body, the separator can have a further simple structure. In addition, when the first area is the area inside the separation member; the second area is the area outside the separation member; the oil inlet and the oil outlet are provided respectively to the both end surface portions of the separator main body; and the fuel outlet is provided to the side surface portion of the separator main body; an oil flow path is formed linearly from the oil inlet to the cylindrical separation member to the oil outlet. Even when the separator is built into a lubricating circuit of an internal combustion engine, the oil in the lubricating circuit is not prevented from flowing, and a smooth flow of the oil is ensured. Further, when the first area is the area outside the separation member; the second area is the area inside the separation member; the oil inlet and the oil outlet are provided respectively to the side surface portions of the separator main body; and the fuel outlet is provided to the end surface portion of the separator main body; a capacity of the first area in which the oil flows can be set large. When the separation member has a same cross section area, a filtration area can be set large, compared to a case in which the fuel is filtered from the inside first area to the outside second area. Further, when the swirler is provided to flow the oil in a spiral pattern in the first area, the oil heated by the heater is stirred and thus evenly heated, and thus the fuel components are efficiently gasified from the flowing oil as a whole. Particularly, when the first area is outside the separation member, and the second area is inside the separation member, the oil flows in a spiral pattern. The fuel components having a lower specific gravity than the oil then gather on a central side of the flow, and thus be more efficiently separated by the separation member. Further, when the heating controller is provided, which activates the heater only when the oil temperature is lower than a predetermined temperature, the heater is activated to separate the fuel components from the oil when the oil temperature is not sufficiently increased at the time of engine start-up and the like. Meanwhile, the heater is deactivated when the engine has operated for a certain period of time and the oil temperature has been sufficiently increased by heat from the engine. Thereby, oil deterioration due to heat can be prevented, and energy consumption can be limited.

When the ceramic filter has the separation membrane having a plurality of fine pores permeable for the fuel components and the supporting body having a plurality of fine pores having a diameter larger than that of the fine pores of the separation membrane, a high performance separator can be achieved having an excellent filtration performance.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is an entire circuit diagram, including an engine, of a separator according to present embodiments;

FIG. 2 is a longitudinal cross-sectional view of a separator according to a first embodiment;

FIG. 3 is a cross-sectional view of the separator along line I-I of FIG. 2;

FIG. 4A is a cross-sectional view of the separation member according to the present embodiments, when a separation membrane is provided on an internal surface of a supporting body (cross-section along line II-II of FIG. 2);

FIG. 4B is a cross-sectional view of the separation member according to the present embodiments, when the separation membrane is provided on an external surface of the supporting body (cross-section along line III-III of FIG. 5);

FIG. 5 is a longitudinal cross-sectional view of a separator according to a second embodiment;

FIG. 6 is a longitudinal cross-sectional view of a separator according to a third embodiment;

FIG. 7 is a cross-sectional view of the separator along line IV-IV of FIG. 6;

FIG. 8A is a lateral cross-sectional view illustrating a separation member according to an alternative embodiment, when a separation membrane is provided on an internal surface of a supporting body;

FIG. 8B is a lateral cross-sectional view illustrating the separation member according to the alternative embodiment, when the separation membrane is provided on an external surface of the supporting body;

FIG. 9 is a lateral cross-sectional view illustrating a separation member according to an alternative embodiment;

FIG. 10 is a longitudinal cross-sectional view illustrating a separator according to the alternative embodiment;

FIG. 11 is a lateral cross-sectional view illustrating a separation member according to an alternative embodiment;

FIG. 12 is a longitudinal cross-sectional view illustrating a separator according to the alternative embodiment; and

FIG. 13 is an entire circuit diagram including an engine of a separator according to an alternative embodiment.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

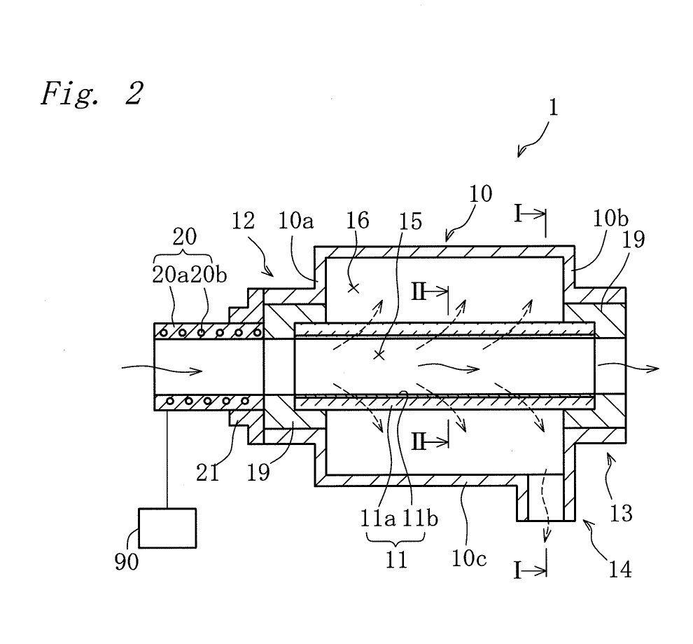

The separator according to the present embodiments is a separator that separates fuel components from oil diluted by fuel in a crossflow filtration method. The separator includes the separator main body, the separation member, the oil inlet, the oil outlet, the fuel outlet, and the heater, which are described hereinafter. The crossflow filtration method is a filtration method in which only a portion of a flow passes through a filter material (refer to FIGS. 2, 5, 6, 10, 12, and the like, for example).

A structure, a shape, a material, and the like of the above-described “separator main body” are not particularly limited, as far as the separator main body separates fuel components from oil fed thereinto. Examples of the separator main body material include metal, including iron and aluminum, resin, and the like. Examples of the separator main body shape include a cylindrical shape; a rectangular cylindrical shape (for example, a rectangular, including a square and an oblong, a hexagon, an octagon, etc.); and the like.

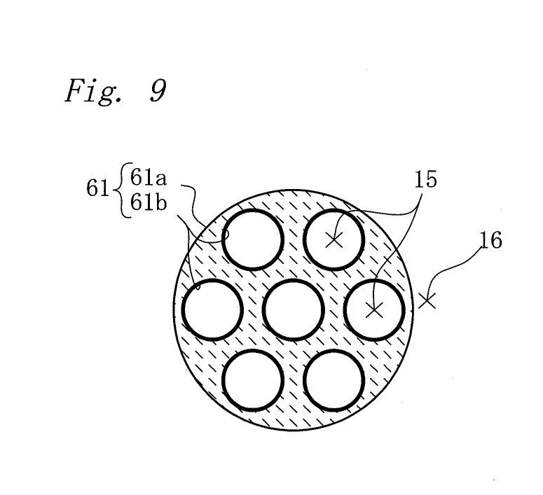

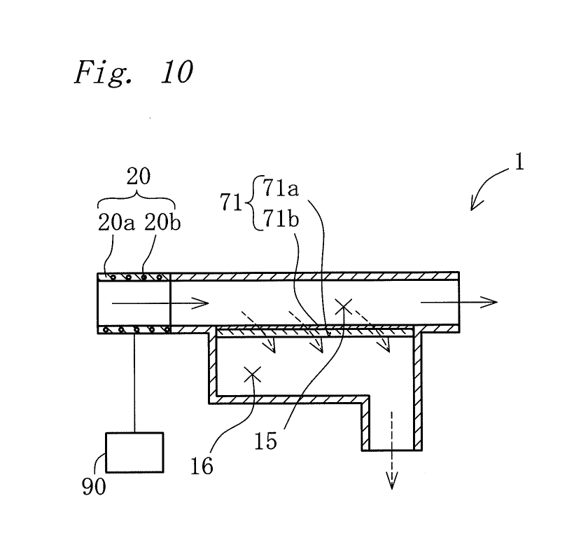

A structure, a shape, a material, and the like of the above-described “separation member” are not particularly limited, as far as the separation member is provided inside the separator main body, partitions the inside of the separator main body into the first area and the second area, and allows fuel components contained in oil to permeate and thus separates the fuel components. Examples of the separation member shape include a cylindrical shape (refer to FIGS. 2 to 8, and the like, for example); a rectangular cylindrical shape (for example, a rectangular, including a square and an oblong, a hexagon, an octagon, and the like); a columnar shape having two or more through-holes in a longitudinal direction (refer to FIG. 9 and the like, for example); a flat plate shape (refer to FIG. 10 and the like, for example); a curved plate shape; a flexed plate shape; and the like. Examples of the separation member material include ceramics, resin, and the like. Examples of the separation member structure include an integrally structured separation member having a plurality of fine pores permeable for fuel components; and a structure in which a separation membrane is provided on a surface of a supporting body, the separation membrane having a plurality of fine pores permeable for fuel components, the supporting body having a plurality of fine pores having a larger diameter than that of the fine pores of the separation membrane.

When the separation member is provided with the separation membrane and the supporting body, it is preferable that the separation membrane have a thickness of 5 μm to 20 μm, and that the supporting body have a thickness of 1 mm to 5 mm. The material of the components may be same or different. Further, at least one layer may be provided between the separation membrane and the supporting body.

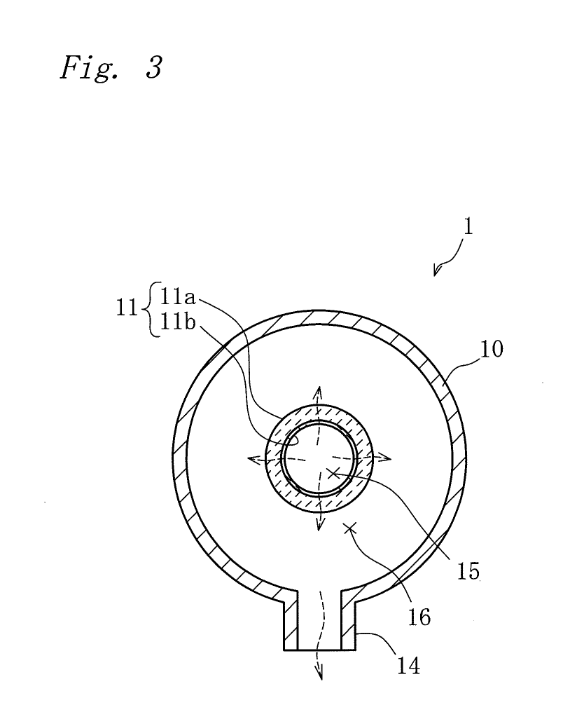

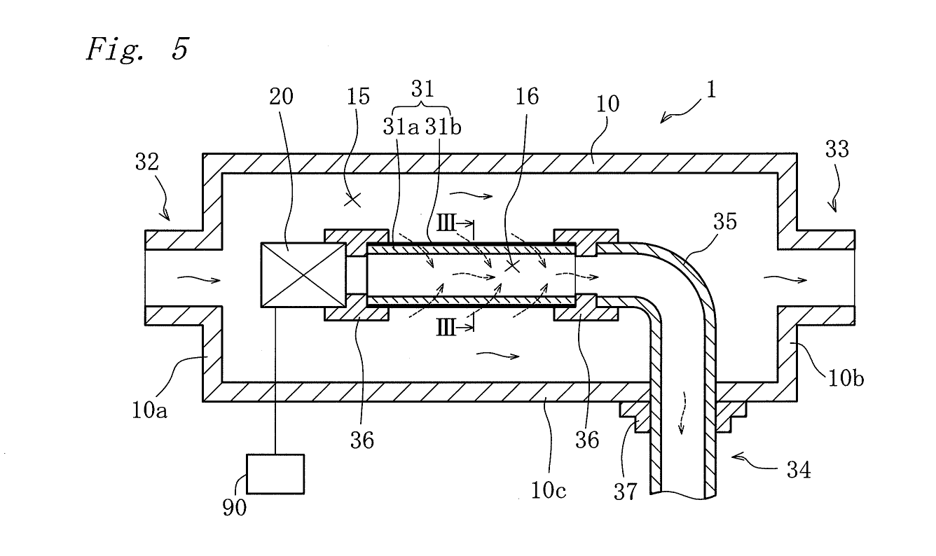

Examples of a partition pattern by the separation member inside the separator main body include (1) that at least one cylindrical separation member or a columnar separation member having two or more through-holes is used to partition the inside of the separator main body into the first area inside the separation member and the second area outside the separation member (refer to FIGS. 2, 3, and the like, for example); (2) that at least one cylindrical separation member or a columnar separation member having two or more through-holes is used to partition the inside of the separator main body into the first area outside the separation member and the second area inside the separation member (refer to FIGS. 5 to 7, and the like, for example); and (3) that a planar separation member is used to partition the inside of the separator main body into the laterally adjacent first area and second area (refer to FIG. 10 and the like, for example).

A shape, a placement pattern, and the like of the above-described “oil inlet” are not particularly limited, as far as the oil inlet is provided to the separator main body and feeds oil to the first area. A shape, a placement pattern, and the like of the above-described “oil outlet” are not particularly limited, as far as the oil outlet is provided to the separator main body and discharges oil from the first area. A shape, a placement pattern, and the like of the above-described “fuel outlet” are not particularly limited, as far as the fuel outlet is provided to the separator main body and discharges fuel components from the second area. The fuel outlet may be connected, for example, to an intake side of an internal combustion engine, to a storage tank storing separated fuel, or to a processor further processing the separated fuel.

A structure, a shape, a placement pattern, and the like of the above-described “heater” are not particularly limited, as far as the heater is provided on the upstream side of the separation member and heats oil before the oil reaches the separation member. The heater may be provided, for example, as a heater having a cylindrical heater main body in which heating wires are provided; a heater having a cylindrical heater main body to which heating wires are provided on an internal periphery surface or external periphery surface thereof; or a heater having a cylindrical heater main body using exhaust gas or cooling water as a heat source. A heating temperature of the heater may be 80° C. to 130° C., for instance, given that a maximum oil temperature during normal engine operation is 130° C.

When the partition pattern by the above-described separation member inside the separator main body is (1), for example, an internal diameter of the heater can be the same as that of the separation member. When the partition pattern by the above-described separation member inside the separator main body is (2), for example, an external diameter of the heater can be the same as that of the separation member. Thereby, gasified oil having been heated by the heater is directly supplied to the separation membrane of the separation member, thus allowing efficient separation of fuel components.

A heating controller can be provided, which activates the heater only when an oil temperature is lower than a predetermined temperature. The heating controller activates the heater, when the oil temperature is not sufficiently increased at the time of engine start-up and the like, for example, when the oil temperature is less than 80° C. Meanwhile, the heating controller deactivates the heater, when the engine has operated for a certain period of time and thus the oil temperature has been sufficiently increased by heat from the engine, for example, when the oil temperature reaches 100° C. As the heating controller, an ECU, which controls an engine, may be used, or a new device may be provided. As a temperature sensor of the heating controller, an oil temperature sensor, which is pre-installed in the engine, may be used, or a new device may be installed.

When the fuel is gasoline, the temperature needs to be increased up to around 180° C. in order to gasify entire components, since the fuel is a mixture of components having various molecular weights. Since the oil temperature also increases to around 130° C. during normal engine operation, most of the fuel components are gasified even when the oil is not heated by the heater. However, when the engine is frequently started and stopped in a repeated manner, or when a driving time is short, such as a travel in a short distance, for instance, the oil temperature does not increase to the temperature at the time of normal engine operation, and thus the fuel components are not sufficiently gasified. In this case, heating control by the heating controller is significantly effective, in which the heater is activated when the oil temperature is less than 80° C., for example, and is deactivated when the oil temperature reaches 100° C.

When the above-described separator main body has a cylindrical shape, the above-described separation member is at least one cylindrical member or a columnar member having two or more through-holes, and the partition pattern by the separation member inside the separator main body is (1) above, the above-described oil inlet and oil outlet can be provided respectively to both end surface portions of the separator main body (refer to FIGS. 2, 3, and the like, for example). In this case, it is preferable that the above-described oil inlet and oil outlet be provided linearly by way of the separation member, since oil can flow smoothly.

When the above-described separator main body has a cylindrical shape, the above-described separation member is at least one cylindrical member or a columnar member having two or more through-holes, and the partition pattern by the separation member inside the separator main body is (2) above, the above-described oil inlet can be provided to a side surface portion of the separator main body, such that oil is fed tangentially; and the above-described oil outlet can be provided to a side surface portion of the separator main body, such that oil is discharged tangentially (refer to FIGS. 5 to 7, and the like, for example). Thereby, the fed and discharged oil can provide turning force to the oil in the first area. In this case, it is preferable that the above-described oil inlet and oil outlet be provided on side surfaces of both end surface sides of the separator main body having a distance in between. Thereby, the oil is more swirled in the separator main body from feeding to the oil inlet to discharging from the oil outlet. In addition, when the above-described separator main body has a cylindrical shape, the above-described separation member is at least one cylindrical member or a columnar member having two or more through-holes, and the partition pattern by the separation member inside the separator main body is (2) above, the heater can be provided in the separator main body on the upstream side of the separation member. In this case, the above-described oil inlet and oil outlet be provided respectively to the both end surface portions of the separator main body (refer to FIG. 5 and the like, for example).

A swirler can be provided to flow the oil in a spiral pattern in the first area. The swirler can be provided by forming into a spiral shape, an internal periphery surface of the separator main body or a surface of the heater contacting the oil. Alternatively, spiral heating wires may be provided on the surface of the heater contacting the oil. Further, when the partition pattern by the separation member inside the separator main body is (2) above, the swirler can be provided by providing the oil inlet and the oil outlet, such that the oil is fed and discharged tangentially to and from the side surface portions of the separator main body. It is preferable that a spiral flow caused by the swirler be, for example, sufficient to stir flowing oil, when the partition pattern by the separation member inside the separator main body is (1) or (3) above; or sufficient to cause a centrifugal effect by swirling, when the partition pattern by the separation member inside the separator main body is (2) above.

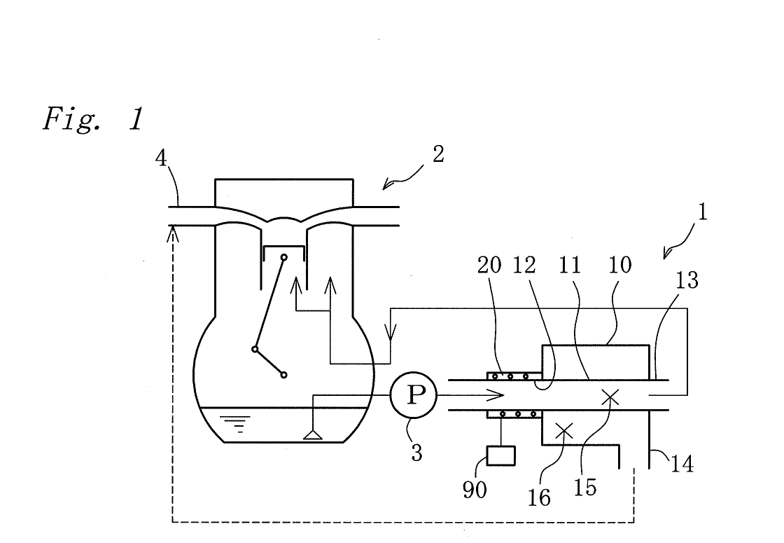

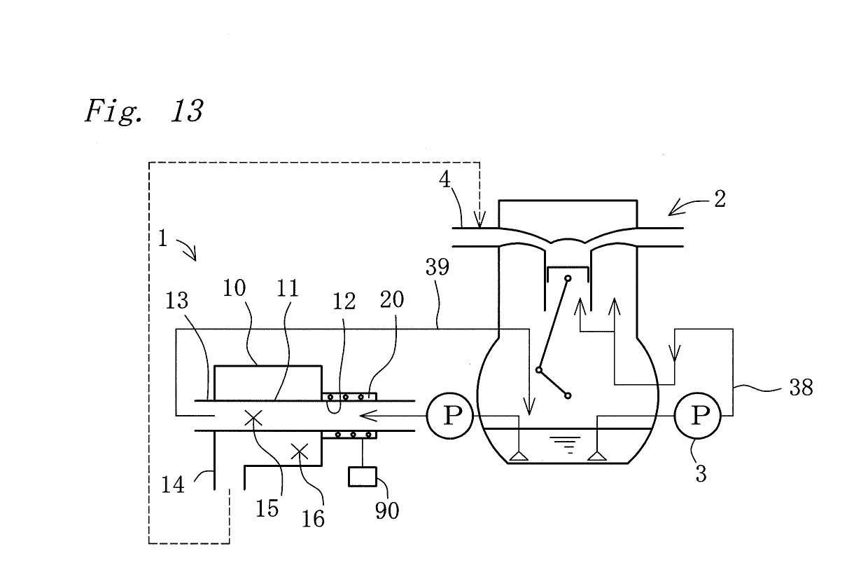

The separator according to the present embodiments can be provided in a lubricating circuit of an internal combustion engine (refer to FIG. 1 and the like, for example) or as a separation circuit of a separate system independent from the lubricating circuit (refer to FIG. 13 and the like, for example). Examples of the internal combustion engine include a gasoline engine, a diesel engine, a biofuel engine, and the like. Thus, examples of the fuel separated by the separator according to the present embodiments include gasoline, diesel fuel, biofuel, and the like.

The present invention is explained specifically below in first to third embodiments with reference to the drawings. In the first to third embodiments, an example of a “separator” according to the present invention is provided as a separator that separates fuel components from oil lubricating a wet sump engine.

### First Embodiment

(1) Structure of the Separator

A separator 1 according to the first embodiment is provided on a discharge side of a lubrication pump 3, as shown in FIG. 1. The lubrication pump 3 in a lubricating circuit of a wet sump engine 2 (hereinafter simply referred to an “engine”) pumps oil to respective parts of the engine 2.

The separator 1 is provided with a cylindrical separator main body 10 formed from metal, as shown in FIGS. 2 and 3. A ceramic filter 11 (provided as an example of a separation member of the present invention) is provided inside the separator main body 10. Both end portions of the ceramic filter 11 are attached to both end surface portions 10a and 10b of the separator main body 10 by way of ring members 19 having stepped holes. An inside of the separator main body 10 is partitioned by the ceramic filter 11, into a first area 15 inside the ceramic filter 11 and a second area 16 outside the ceramic filter 11. Further, an oil inlet 12 is provided to the first end surface portion 10a of the separator main body 10, the oil inlet 12 feeding oil to the first area 15 in the separator main body 10. An oil outlet 13 is provided to the second end surface portion 10b of the separator main body 10, the oil outlet 13 discharging oil from the first area 15 in the separator main body 10.

A heater 20 that heats oil is connected on an upstream side of the oil inlet 12 by way of a flange 21. The heater 20 includes a cylindrical heater main body 20a and heating wires 20b provided inside the heater main body 20. The heater 20 has an internal diameter identical to that of the ceramic filter 11. The heater 20 instantaneously and locally heats oil flowing inside the heater main body 20a by conducting a current to the heating wires 20b. A heating temperature is set to 130° C. Further, a heating controller 90 is provided to turn on and off the heater 20 in accordance with comparison results of an oil temperature and a predetermined temperature. The heating controller 90 is provided as an ECU that controls the engine 2. An oil temperature sensor (not shown in the drawing) pre-installed in the engine 2 is used as a temperature sensor for the heating controller 90. When the oil temperature is less than 80° C., the heating controller 90 activates the heater 20. When the oil temperature reaches 100° C., the heating controller 90 deactivates the heater 20. In addition, a fuel outlet 14 is provided to a side surface portion 10c on an external periphery side of the separator main body 10. The fuel outlet 14 discharges fuel components, which have separated from the oil fed to the first area 15 in the separator main body 10, permeated the ceramic filter 11, and reached the second area 16. Another end side of the fuel outlet 14 is connected to an intake pipe 4 of the engine 2.

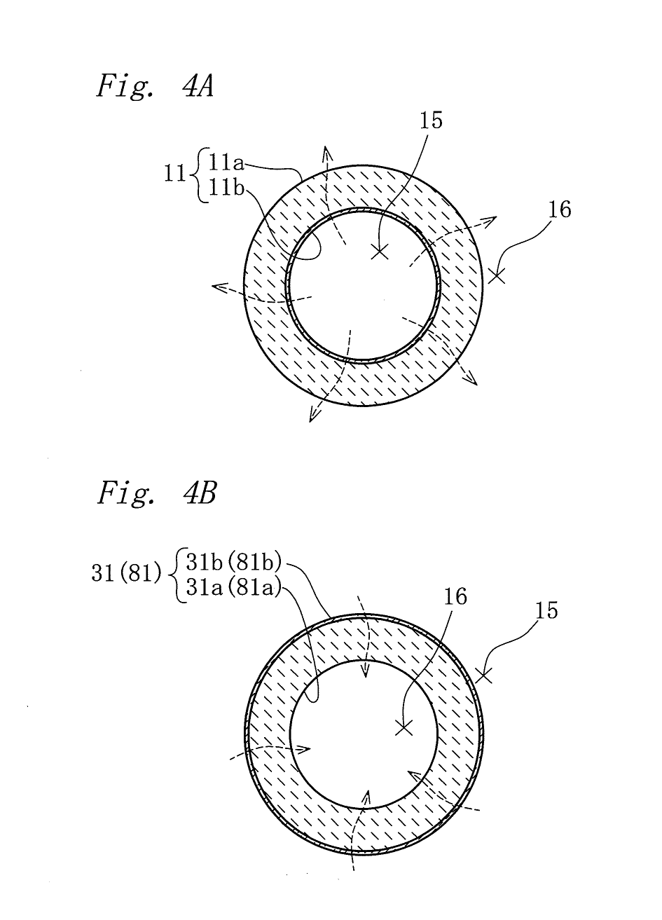

As shown in FIG. 4A, the above-described ceramic filter 11 has a two-layer structure that includes a supporting body 11a and a separation membrane 11b. The supporting body 11a has a plurality of fine pores. The separation membrane 11b, which is provided inside the supporting body 11a, has a plurality of fine pores having a smaller diameter than that of the fine pores of the supporting body 11a and being permeable for fuel components. The ceramic filter 11 has an external diameter of about 10 mm, an internal diameter of about 7 mm, and a thickness of about 10 μm at the separation membrane 11b. An average diameter of the fine pores provided in the supporting body 11a is about 10 μm, whereas an average diameter of the fine pores provided in the separation membrane 11b is about 20 nm. Fuel, including gasoline and the like, used for an internal combustion engine has a molecular structure in which one molecule has about 4 to 13 carbon atoms, whereas oil has 25 or more carbon atoms per molecule. The difference in the molecular structure above allows the ceramic filter 11 to separate fuel components mixed in oil, since a molecular diameter of the fuel is smaller than the diameter of the fine pores of the separation membrane 11b, and a molecular diameter of the oil is larger than the diameter of the fine pores of the separation membrane 11b. Further, the fine pore diameter of the supporting body 11a is extremely large compared to the fine pore diameter of the separation membrane 11b. Thus, the fuel components having passed through the separation membrane 11b can pass through the supporting body 11a with a smaller resistance than a resistance applied at the time of passing through the separation membrane 11b.

(2) Functions of the Separator

Functions of the separator 1 having the above-described structure is explained below. Oil discharged from the lubrication pump 3 is first fed to the heater 20. Then, the heating controller 90 detects the oil temperature. When the oil temperature is not sufficiently increased at the time of engine start-up and the like, more specifically, when the oil temperature is less than 80° C., the heating controller 90 activates the heater 20. Then, the heater 20, which has a temperature of 130° C., instantaneously and locally heats the oil. Or, when the engine 2 has operated for a certain period of time and the oil temperature has been sufficiently increased by heat from the engine 2, more specifically, when the oil temperature has reached 100° C., the heating controller 90 deactivates the heater 20. Thereby, the oil is surely heated to 80° C. or more. Fuel components in the oil then partially gasify, thus increasing pressure. While maintaining a high pressure, the oil having passed through the heater 20 is fed from the oil inlet 12 to the first area 15 inside the ceramic filter 11. At the time, a pressure in the first area 15 is higher than that in the second area 16, due to the pressure increase associated with gasification of the fuel components, in addition to discharge pressure from the lubrication pump 3. Because of the large pressure difference, the fuel components contained in the oil fed to the first area 15 permeate the ceramic filter 11, reach the second area 16, and then discharge from the fuel outlet 14 to outside the separator 1. Since the fuel components are discharged in a tangential direction of the separator main body 10, the fuel in the second area 16 swirls therein. Further, the oil, which has a reduced fuel dilution rate after the fuel components have been separated, is discharged from the oil outlet 13, and then pressure-fed to respective parts of the engine 2. Furthermore, the separated fuel is fed to the intake pipe 4 of the engine 2, where the fuel undergoes combustion.

(3) Effects of the Embodiment

In the separator 1 according to the first embodiment, as described above, the heater 20 instantaneously and locally heats the oil, and thus gasifies the fuel components and increases the pressure; and the ceramic filter 11 separates the fuel components from the oil. Unlike a conventional separator, the separator of the present embodiment requires no large heater and the like for heating oil as a whole, and gasifying and separating fuel components, and thus can have a simple structure. In addition, since the oil only needs to be heated instantaneously and locally, no excessive heating is necessary to increase the temperature of the entire oil, unlike conventional heating. Thus, oil deterioration due to heat can be prevented. Further, energy consumption can be limited.

A crossflow filtration method employed in the present embodiment prevents solid components, such as metal powder in the oil and the like, from depositing on a surface of the ceramic filter 11 and clogging the ceramic filter 11, and thereby prevents a decline in performance of the ceramic filter 11.

Further, the first area 15 is the area inside the ceramic filter 11; the second area 16 is the area outside the ceramic filter 11; the oil inlet 12 and the oil outlet 13 are provided respectively to the both end surface portions of the separator main body 10; and the fuel outlet 14 is provided to the side surface portion of the separator main body 10. Thus, an oil flow path is formed linearly from the oil inlet 12 to the cylindrical ceramic filter 11 to the oil outlet 13. Thereby, the oil flow in the lubricating circuit is not prevented, and thus a smooth flow of the oil is ensured. In addition, the internal diameter of the heater 20 and that of the ceramic filter 11 are identical. Thus, the gasified oil, which has been heated by the heater 20 and is located near the internal periphery surface, is directly supplied to the separation membrane 11b of the ceramic filter 11. Thereby, the fuel components can efficiently be separated. Further, the heating controller 90 is provided, which activates the heater 20 only when the oil temperature is lower than 80° C. Thus, the heater 20 is activated to separate the fuel components from the oil, when the oil temperature is not sufficiently increased at the time of engine start-up and the like. Meanwhile, the heater 20 is deactivated, when the engine has operated for a certain period of time and the oil temperature has been sufficiently increased by heat from the engine. Thereby, oil deterioration due to heat can be prevented, and energy consumption can be limited.

### Second Embodiment

A separator according to the second embodiment is explained below. In the separator according to the second embodiment, same reference numerals are provided to components substantially the same as the separator 1 of the above-described first embodiment, and detailed explanations of the components are omitted. Similar to the above-described first embodiment, a separator 1 according to the second embodiment is provided on a discharge side of a lubrication pump 3. The lubrication pump 3 pumps oil in a lubricating circuit of an engine 2 to respective parts of the engine 2.

(1) Structure of the Separator

The separator 1 according to the second embodiment is provided, as shown in FIG. 5, with a cylindrical separator main body 10 having an oil inlet 32 feeding oil to inside and an oil outlet 33 discharging the oil. A cylindrical ceramic filter 31 is provided inside the separator main body 10. An inside of the separator main body 10 is partitioned by the ceramic filter 31, into a first area 15 outside the ceramic filter 31 and a second area 16 inside the ceramic filter 31.

A heater 20 is provided on an upstream side of the ceramic filter 31. The heater 20 is not a cylindrical heater as used in the first embodiment, but the heater 20 is a columnar heater internally provided with heating wires. The heater 20 closes an opening on the upstream side of the ceramic filter 31. A outlet pipe 35 is connected on a downstream side of the ceramic filter 31. The outlet pipe 35 discharges fuel components which have separated from the oil fed to the first area 15 in the separator main body 10, permeated the ceramic filter 31, and reached the second area 16. A through-hole is provided in a portion of a side surface portion 10c of the separator main body 10, and thereby the outlet pipe 35 is connected to outside as a fuel outlet 34. The fuel outlet 34 is connected to an intake pipe 4 of the engine 2. In the drawing, a connector 36 is provided to connect the upstream side and the downstream side of the ceramic filter 31; and a flange 37 is provided to fix the outlet pipe 35. Further, a heating controller 90 is provided, similar to the first embodiment, to turn on and off the heater 20 in accordance with comparison results of an oil temperature and a predetermined temperature.

Whereas the ceramic filter 11 of the above-described first embodiment has the separation membrane 11b inside the supporting body 11a, the ceramic filter 31 of the second embodiment has a separation membrane 31b outside a supporting body 31a, as shown in FIG. 4B. This is because, whereas the fuel components permeate from the first area 15 inside the ceramic filter 11 to the outside second area 16 in the above-described first embodiment, the fuel components permeate from the first area 15 outside the ceramic filter 31 to the inside second area 16 in the second embodiment.

(2) Functions of the Separator

Functions of the separator 1 having the above-described structure are explained below. Oil discharged from the lubrication pump 3 is first fed to the separator main body 10 from the oil inlet 32, and then fed to the first area 15 outside the ceramic filter 31. Then, the heating controller 90 detects the oil temperature. When the oil temperature is less than 80° C., the heating controller 90 activates the heater 20, which instantaneously and locally heats the oil. Or, when the oil temperature has reached 100° C., the heating controller 90 deactivates the heater 20. Thereby, the oil is surely heated to 80° C. or more. Fuel components in the oil then partially gasify, thus increasing pressure. A pressure in the first area 15 is higher than that in the second area 16, due to discharge pressure from the lubrication pump 3, in addition to the pressure increase associated with gasification of the fuel components. Because of the large pressure difference, the fuel components contained in the oil fed to the first area 15 permeate the ceramic filter 31, reach the second area 16, and then discharge from the fuel outlet 34 to outside the separator 1. Further, the oil, which has a reduced fuel dilution rate after the fuel components have been separated, is discharged from the oil outlet 33, and then pressure-fed to respective parts of the engine 2. Furthermore, the separated fuel is fed to the intake pipe 4 of the engine 2, where the fuel undergoes combustion.

(3) Effects of the Embodiment

In the separator 1 according to the second embodiment, similar to the above-described first embodiment, the heater 20 instantaneously and locally heats the oil, and thus gasifies the fuel components and increases the pressure; and the ceramic filter 31 separates the fuel components from the oil. Unlike a conventional separator, the separator of the present embodiment requires no large heater and the like for heating oil as a whole, and thus can have a simple structure. In addition, since the oil only needs to be heated instantaneously and locally, no excessive heating is necessary to increase the temperature of the entire oil, unlike the conventional heating. Thus, oil deterioration due to heat can be prevented. Further, energy consumption can be limited.

Similar to the above-described first embodiment, a crossflow filtration method employed in the separator 1 of the second embodiment prevents solid components, such as metal powder in the oil and the like, from depositing on a surface of the ceramic filter 31 and clogging the ceramic filter 31, and thereby prevents a decline in performance of the ceramic filter 31. Further, in the separator 1 of the second embodiment, the heating controller 90 is provided, which activates the heater 20 only when the oil temperature is lower than 80° C., similar to the above-described first embodiment. Thus, the heater 20 is activated to separate the fuel components from the oil when the oil temperature is not sufficiently increased at the time of engine start-up and the like. Meanwhile, the heater 20 is deactivated when the engine has operated for a certain period of time and the oil temperature has been sufficiently increased by heat from the engine. Thereby, oil deterioration due to heat can be prevented, and energy consumption can be limited.

In addition, the separation membrane 31b of the ceramic filter 31 is provided outside the supporting body 31a in the separator 1 of the second embodiment. Compared to a case in which the separation membrane 11b is provided inside the supporting body 11a as in the above-described first embodiment, a surface area, more specifically, a filtration area of the separation membrane 31b can be set large (refer to FIGS. 4A and 4B).

Further, the outside of the ceramic filter 31 is the first area 15 in which the oil flows and the inside thereof is the second area 16 in which the separated fuel flows, in the separator 1 of the second embodiment. A capacity of the first area 15 in which the oil flows can thus be set large, compared to the above-described first embodiment.

### Third Embodiment

A separator according to the third embodiment is explained below. In the separator according to the third embodiment, same reference numerals are provided to components substantially the same as the separator 1 of the above-described first embodiment, and detailed explanations of the components are omitted. Similar to the above-described first embodiment, a separator 1 according to the third embodiment is provided on a discharge side of a lubrication pump 3. The lubrication pump 3 pumps oil in a lubricating circuit of an engine 2 to respective parts of the engine 2.

(1) Structure of the Separator

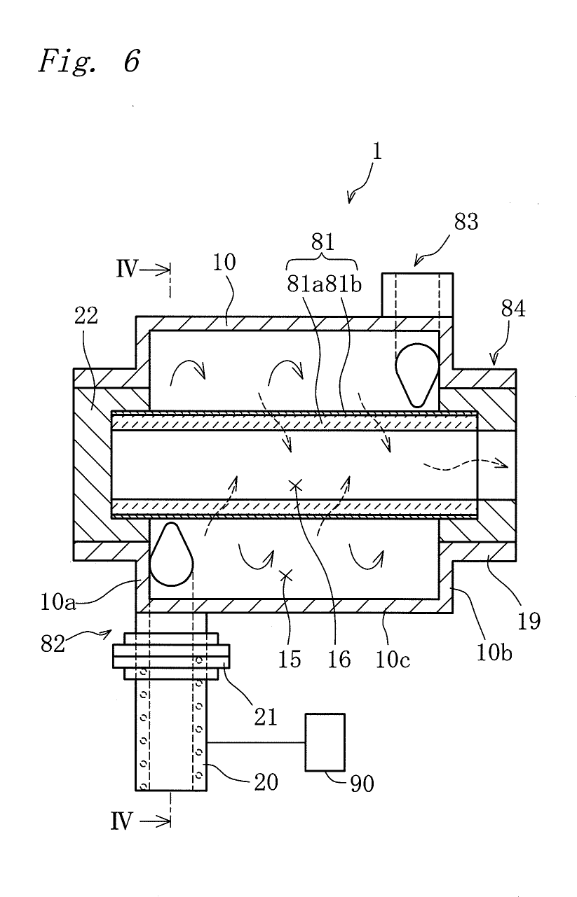

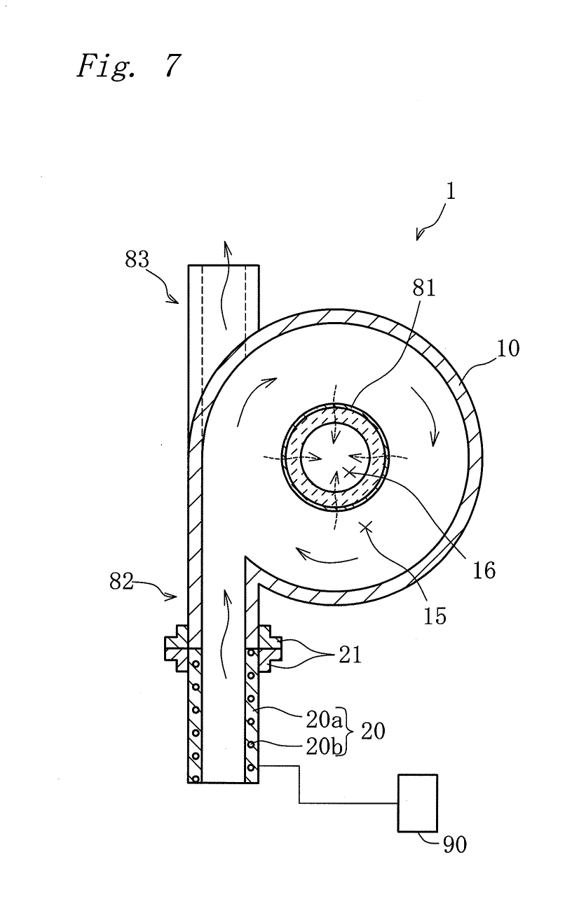

The separator 1 according to the third embodiment is provided with a ceramic filter 81. As shown in FIGS. 6 and 7, both end portions of the ceramic filter 81 are attached to an end surface portion 10a of a separator main body 10 by way of a lid member 22 and to an end surface portion 10b by way of a ring member 19 having a stepped hole. An inside of the separator main body 10 is partitioned by the ceramic filter 81, into a first area 15 outside the ceramic filter 81 and a second area 16 inside the ceramic filter 81. Further, an oil inlet 82 and an oil outlet 83 are provided to an end surface portion 10c on an external periphery side of the separator main body 10, the oil inlet 82 feeding oil to the first area 15 in the separator main body 10, the oil outlet 83 discharging oil from the first area 15 in the separator main body 10. The oil inlet (provided as an example of a swirler according to the present invention) 82 is provided so as to feed the oil in a tangential direction of the separator main body 10. The oil outlet 83 is provided so as to discharge the oil in the tangential direction of the separator main body 10. Further, a fuel outlet 84 is provided to the end surface portion 10b, which is one end side of the separator main body 10. The fuel outlet 84 discharges fuel components, which have separated from the oil fed to the first area 15 in the separator main body 10, permeated the ceramic filter 81, and reached the second area 16. Another end side of the fuel outlet 84 is connected to an intake pipe 4 of the engine 2.

A heater 20 that heats the oil is connected to an upstream side of the oil inlet 82 by way of a flange 21, similar to the first embodiment. The heater 20 has a structure similar to that of the first embodiment. Further, a heating controller 90 is provided, similar to the first embodiment, to turn on and off the heater 20 in accordance with comparison results of an oil temperature and a predetermined temperature.

Whereas the ceramic filter 11 of the above-described first embodiment has the separation membrane 11b inside the supporting body 11a, the ceramic filter 81 of the third embodiment, similar to the ceramic filter 31 of the second embodiment, has a separation membrane 81b outside a supporting body 81a, as shown in FIG. 4B. This is because, whereas the fuel components permeate from the first area 15 inside the ceramic filter 11 to the outside second area 16 in the above-described first embodiment, the fuel components permeate from the first area 15 outside the ceramic filter 81 to the inside second area 16 in the third embodiment.

(2) Functions of the Separator

Functions of the separator 1 having the above-described structure is explained below. Oil discharged from the lubrication pump 3 is first fed to the heater 20. Then, the heating controller 90 detects the oil temperature. When the oil temperature is less than 80° C., the heating controller 90 activates the heater 20, which then instantaneously and locally heats the oil. When the oil temperature has reached 100° C., the heating controller 90 deactivates the heater 20. Thereby, the oil is surely heated to 80° C. or more. Fuel components in the oil then partially gasify, thus increasing pressure.

While maintaining a high pressure, the oil having passed through the heater 20 is fed from the oil inlet 82 to the first area 15 outside the ceramic filter 81. At the time, the oil is fed from the oil inlet 82 in the tangential direction of the separator main body 10, and flows in a spiral pattern in the first area 15 (refer to arrows in FIGS. 6 and 7). A pressure in the first area 15 is higher than that in the second area 16, due to discharge pressure from the lubrication pump 3, in addition to the pressure increase associated with gasification of the fuel components. Because of the large pressure difference, the fuel components contained in the oil fed to the first area 15 permeate the ceramic filter 81, reach the second area 16, and then discharge from the fuel outlet 84 to outside the separator 1. Further, the oil, which has a reduced fuel dilution rate after the fuel components have been separated, is discharged from the oil outlet 83, and then pressure-fed to respective parts of the engine 2. Furthermore, the separated fuel is fed to the intake pipe 4 of the engine 2, where the fuel undergoes combustion.

(3) Effects of the Embodiment

In the separator 1 according to the third embodiment, similar to the above-described first embodiment, the heater 20 instantaneously and locally heats the oil, and thus gasifies the fuel components and increases the pressure; and the ceramic filter 81 separates the fuel components from the oil. Unlike a conventional separator, the separator of the present embodiment requires no large heater and the like for heating oil as a whole, and thus can have a simple structure. In addition, since the oil only needs to be heated instantaneously and locally, no excessive heating is necessary to increase the temperature of the entire oil, unlike conventional heating. Thus, oil deterioration due to heat can be prevented. Further, energy consumption can be limited.

Similar to the above-described first embodiment, a crossflow filtration method employed in the separator 1 of the third embodiment prevents solid components, such as metal powder in the oil and the like, from depositing on a surface of the ceramic filter 81 and clogging the ceramic filter 81, and thereby prevents a decline in performance of the ceramic filter 81. In addition, in the separator 1 of the third embodiment, the oil inlet 82 tangentially feeds the oil to the separator main body 10, and thereby swirls the oil in the first area 15. The centrifugal force is thus exerted on solid components in a centrifugal direction, more specifically, in a direction away from the ceramic filter 81, the solid components including metal powder and the like having a higher specific gravity than the oil. As a result, even fewer solid components, including metal powder and the like, are deposited on the surface of the ceramic filter 81. Thus, the performance of the ceramic filter 81 is further prevented from declining. In addition, since the oil flows in a spiral pattern, the oil heated by the heater 20 is stirred and thus evenly heated. Thus, the fuel components are efficiently gasified from the flowing oil as a whole. Further, due to the centrifugal force caused by the oil swirl, the oil is pulled toward the centrifugal direction of the separator main body 10 since the oil has a higher specific gravity (specific gravity of 0.8) than the fuel, and the fuel having a lower specific gravity (specific gravity of 0.76) is pulled toward an axial center direction. Thereby, separation of the fuel components from the oil is facilitated.

Further, in the separator 1 of the third embodiment, the heating controller 90 is provided, which activates the heater 20 only when the oil temperature is lower than 80° C., similar to the above-described first embodiment. Thus, the heater 20 is activated to separate the fuel components from the oil when the oil temperature is not sufficiently increased at the time of engine start-up and the like. Meanwhile, the heater 20 is deactivated when the engine has operated for a certain period of time and the oil temperature has been sufficiently increased by heat from the engine. Thereby, oil deterioration due to heat can be prevented, and energy consumption can be limited.

In addition, the separation membrane 81b of the ceramic filter 81 is provided outside the supporting body 81a in the separator 1 of the third embodiment. Compared to a case in which the separation membrane 11b is provided inside the supporting body 11a as in the above-described first embodiment, a surface area, more specifically, a filtration area of the separation membrane 81b can be set large (refer to FIGS. 4A and 4B).

Further, the outside of the ceramic filter 81 is the first area 15 in which the oil flows and the inside thereof is the second area 16 in which the separated fuel flows, in the separator 1 of the third embodiment. A capacity of the first area 15 in which the oil flows can thus be set large, compared to the above-described first embodiment.

The present invention is not limited to the above-described first to third embodiments, and may be provided in embodiments modified in various manners within a range of the present invention, in accordance with purposes and uses. Specifically, the heating controller 90 activates the heater 20 only when the oil temperature is lower than 80° C. in the first to third embodiments. However, the temperature is not limited to 80° C., and may be set otherwise. Further, the heating temperature of the heater 20 is 130° C. in the first to third embodiments. However, the temperature is not limited as above, and may be set otherwise. Furthermore, the heater 20 is provided with the heater main body 20a, in which the heating wires 20b are provided, in the first to third embodiments. However, the heater is not limited as above. The heater may be provided with the heater main body 20a, to which the heating wires 20b are provided on an internal periphery surface or an external periphery surface. Alternatively, the heater may employ exhaust gas or cooling water as a heat source for the heater main body 20a.

In the above-described third embodiment, the tangentially provided oil inlet 82 serves as the swirler. However, the swirler is not limited as above. A spiral groove and the like may be provided on an internal periphery surface of the separator main body 10 or on a surface of the heater 20 contacting the oil. Alternatively, spiral heating wires 20b may be provided on a surface of the heater 20 contacting the oil. Further, the heater 20 and the ceramic filter 11, 31, or 81 are provided apart in the first to third embodiments. However, the placement of the components is not limited as above. For instance, a downstream side end portion of the heater 20 may be fitted into an external periphery portion on an upstream side of the ceramic filter 11, 31, or 81; or may be inserted into an internal periphery portion.

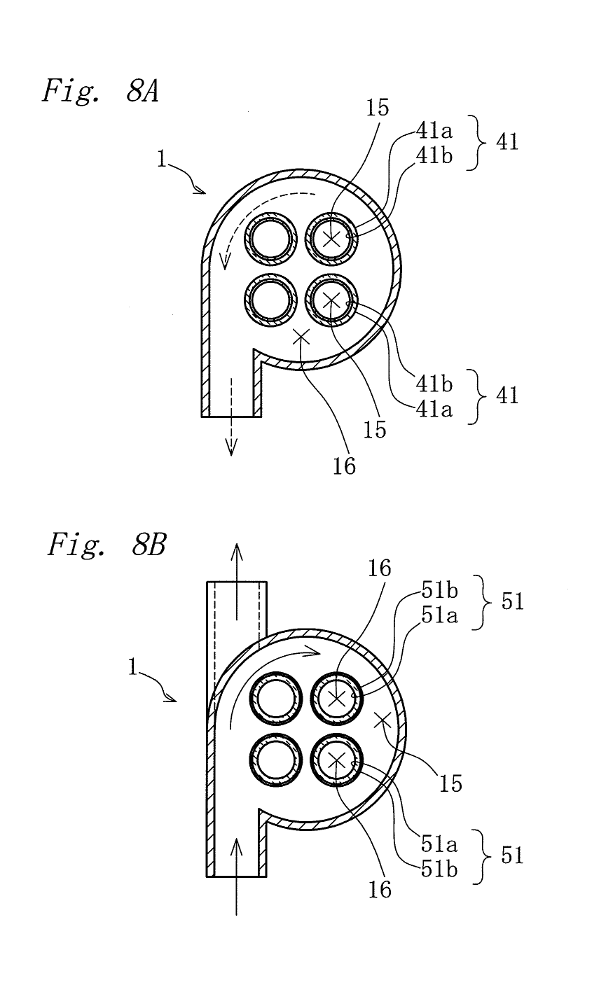

In the above-described first to third embodiments, one cylindrical ceramic filter 11, 31, or 81 is used respectively. However, the ceramic filter is not limited as above. As shown in FIGS. 8A and 8B, two or more tubular ceramic filters 41 and 51 may be used. The ceramic filter 41 has a supporting body 41a and a separation membrane 41b. The ceramic filter 51 has a supporting body 51a and a separation membrane 51b. Compared to the surface area (filtration area) of the separation membrane 11b, 31b, or 81b of the ceramic filter 11, 31, or 81, respectively, in the first to third embodiment, the surface area of the separation membranes 41b and 51b can be set larger when a cross section area of the first area 15 is the same.

In the above-described first embodiment, the cylindrical ceramic filter 11 is employed as an example. However, the ceramic filter is not limited as above. As shown in FIG. 9, for instance, a columnar ceramic filter 61 may be employed. The ceramic filter 61 is provided with two or more through-holes (seven through-holes in the drawing) in a longitudinal direction of a supporting body 61a. A separation membrane 61b is provided on an internal surface of each of the through-holes. Thereby, when the surface area of the separation membrane is the same, the cross section area of the first area 15 can be set small, through which the oil flows. When a velocity of the oil flow is high, solid components, including metal powder and the like, are prevented from depositing on a surface of the separation membrane 61b. When the cross section area of the first area 15 is the same, the surface area of the separation membrane 61b can be set large.

Further, the inside of the separator main body 10 is partitioned into the first area 15 and the second area 16, by the cylindrical ceramic filter 11, 31, or 81, in the above-described first to third embodiments. However, the partition pattern is not limited as above. As shown in FIG. 10, for instance, a planar ceramic filter 71 having a supporting body 71a and a separation membrane 71b may be used to partition the inside of the separator main body 10 into first area 15 and second area 16 adjacent on the left and right.

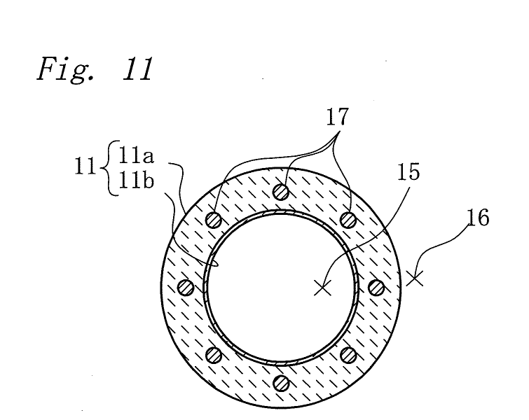

In the above-described first to third embodiment, only the ceramic filter 11, 31, or 81 that separates the fuel components from the oil is employed as an example. However, the ceramic filter is not limited as above. As shown in FIG. 11, for instance, a heater 17 may further be provided to heat the ceramic filter 11, so as to further facilitate separation of the fuel components from the oil.

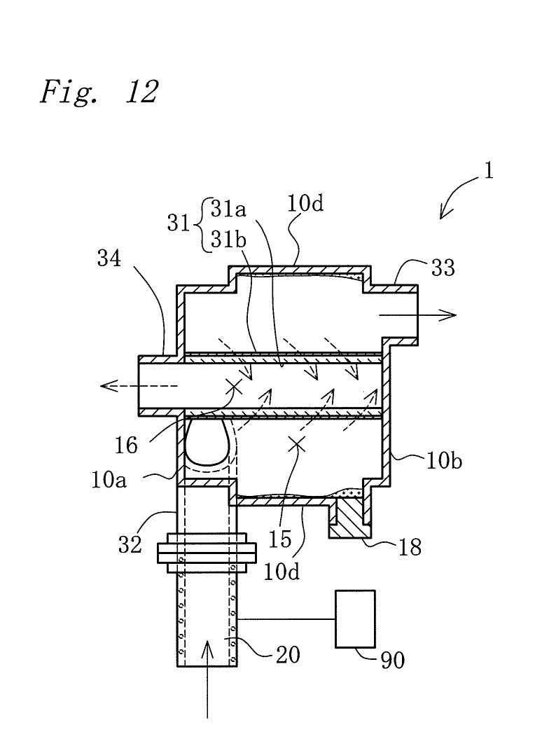

Further, the cylindrical separator main body 10 is used in the above-described third embodiment. However, the separator main body is not limited as above. As shown in FIG. 12, for instance, a stepped cylindrical separator main body 10, which is provided with a stepped portion 10d to a side surface portion 10c thereof, may be used, such that the step is used to separate solid components, including metal powder and the like. Specifically, a force in an external periphery direction of the separator main body 10, which is caused by a centrifugal force of the oil swirling in the first area 15, is exerted on solid components, such as metal powder and the like, having a higher specific gravity than fuel and oil. Thus, the solid components are deposited at the stepped portion 10d, which is a farthest portion from an axial center. Thereby, not only the fuel components, but also the solid components, including metal powder and the like, can be separated from the oil. The deposited solid components, including metal powder and the like, which have a higher specific gravity than the oil, may appropriately be discharged from a drain outlet 18, as shown in FIG. 12, for example.

Furthermore, the separator 1 is provided in the lubricating circuit of the engine 2 on the discharge side of the lubricating pump 3, which pumps the oil to respective parts of the engine 2, in the above-described first to third embodiments. The placement of the separator is not limited as above. For example, the separator may be provided on the intake side of the lubricating pump 3. Alternatively, a circuit 39 exclusively for fuel separation independent from the lubricating circuit 38, may be provided, for example, as shown in FIG. 13.

The present invention is widely used as technology to separate fuel components mixed into oil used for lubricating an internal combustion engine. Particularly, it is suitably used as technology to separate fuel components from oil used in engines in which fuel components are easily mixed into oil, such as direct fuel-injection engines and the like.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

What is claimed is:

1. A separator configured to separate fuel components from oil diluted by fuel in a crossflow filtration method, the separator comprising:
a tubular separator main body;
a separation member provided in the separator main body, and configured to partition an inside of the separator main body into a first area and a second area and further to allow the fuel components contained in the oil to permeate and thus to separate the fuel components;
an oil inlet provided to the separator main body and configured to feed the oil to the first area;
an oil outlet provided to the separator main body and configured to discharge the oil from the first area;
a fuel outlet provided to the separator main body and configured to discharge the fuel components from the second area; and
a heater provided to an upstream side of the separation member and configured to heat the oil before the oil reaches the separation member.

2. The separator according to claim 1, wherein the separator main body has a cylindrical shape, and the separation member has a cylindrical shape in an axial direction of the separator main body.

3. The separator according to claim 2, wherein:
the first area is an area inside the separation member;
the second area is an area outside the separation member;
the oil inlet and the oil outlet are provided respectively to both end surface portions of the separator main body; and
the fuel outlet is provided to a side surface portion of the separator main body.

4. The separator according to claim 2, wherein:
the first area is an area outside the separation member;
the second area is an area inside the separation member;
the oil inlet and the oil outlet are provided respectively to side surface portions of the separator main body; and
the fuel outlet is provided to an end surface portion of the separator main body.

5. The separator according to claim 1, further comprising a swirler configured to flow the oil in a spiral pattern in the first area.

6. The separator according to claim 1, further comprising a heating controller configured to activate the heater only when the oil has a temperature lower than a predetermined temperature.

7. The separator according to claim 1, wherein the separation member is a ceramic filter provided with a separation membrane and a supporting body, the separation membrane having a plurality of fine pores permeable for fuel components, the supporting body having a plurality of fine pores having a diameter larger than that of the fine pores of the separation membrane.
